(19) United States
(12) Patent Application Publication
(10) Pub. No.: US 2024/0092068 A1
(43) Pub. Date: Mar. 21, 2024

(54) Inflatable-Body Pull Belt Structure, Pull Belt, and Inflatable Product

(71) Applicant: DONGGUAN HONGYU PLASTIC CO., LTD, Dongguan City (CN)

(72) Inventor: Juying Shi, Dongguan City (CN)

(21) Appl. No.: 18/147,012

(22) Filed: Dec. 28, 2022

(30) Foreign Application Priority Data
Sep. 15, 2022 (CN) 202222452027.7

(51) Int. Cl. B32B 27/12; B32B 5/02; B32B 27/08; B32B 27/30; B32B 27/36

(52) U.S. Cl. CPC B32B 27/12; B32B 5/02; B32B 27/08; B32B 27/304; B32B 27/36; B32B 2250/24; B32B 2250/40; B32B 2433/00

(57) ABSTRACT

Provided are inflatable-body pull belt structure and inflatable product. The inflatable-body pull belt structure includes annular belt body having hollow region, plural meshes all in communication with the hollow region are provided on the annular belt body, the annular belt body has first connecting end and second connecting end arranged in lengthwise direction of the hollow region, the plural meshes are located between the first connecting end and the second connecting end, which are both connected to the inflatable body. By providing the meshes on the annular belt body, the consumables are reduced, and the costs are reduced. Moreover, by providing the pull belt as combined structure constituted by the pvc membranes and the mesh sheets, the mesh sheets can increase the tensile strength, and the mesh sheets can reduce the consumables, thereby reducing the costs.

### CROSS-REFERENCE TO RELATED APPLICATION

The present disclosure claims the priority to the Chinese patent application 2022224520277 filed on Sep. 15, 2022 and entitled “Inflatable-Body Pull Belt Structure and Inflatable Product”, the contents of which are incorporated herein by reference in entirety.

### TECHNICAL FIELD

The present disclose relates to the field of articles for daily use, particularly to an inflatable-body pull belt structure, a pull belt and an inflatable product.

### BACKGROUND ART

Currently, inflatable products are applied more and more widely, and common inflatable products include inflatable beds, inflatable pillows, inflatable swimming pools, etc. The inflatable bed is an inflatable object that people often use, particularly when going out for travel or for standby use at home. The structure of the inflatable products is generally a square-shaped bed air chamber made of plastic flexible materials, and a pull belt group is arranged between upper and lower bottom surfaces of the square-shaped bed air chamber so as to ensure the flatness of the upper and lower bottom surfaces of the bed air chamber after being inflated. However, since the flexible materials forming the inflatable bed has ductility and can be stretched and elongated, the inflatable bed will be forced to expand outward after inflation. In order to improve the stability of the inflatable product, it is generally required to arrange a pull belt structure inside the inflatable product, and in the prior art, the pull belt is generally an annular belt body made of pvc (polyvinyl chloride).

Upon research, the inventors found that the existing inflatable products have the following defects:

the pull belt requires a large amount of consumables and has high costs.

### SUMMARY

The present disclosure aims at providing an inflatable-body pull belt structure and an inflatable product, which can reduce the consumables, reduce the costs, enhance the tensile capability, and improve the comfort of the inflatable product.

Embodiments of the present disclosure are realized as follows:
in a first aspect, the present disclosure provides an inflatable-body pull belt structure, including:
an annular belt body having a hollow region, wherein a plurality of meshes which are all in communication with the hollow region are provided on the annular belt body, the annular belt body has a first connecting end and a second connecting end which are arranged in a lengthwise direction of the hollow region, the plurality of meshes are located between the first connecting end and the second connecting end, and both the first connecting end and the second connecting end are configured to be connected to the inflatable body.

In an optional embodiment, the annular belt body includes a membrane and a mesh sheet, and the membrane and the mesh sheet are connected and the two define the hollow region together.

In an optional embodiment, the membrane and the mesh sheet are both in an annular shape, and the number of membranes is two and the two membranes are respectively fixedly connected to two ports (ends) of the mesh sheet.

In an optional embodiment, the membrane and the mesh sheet are connected in a manner of high-frequency hot-pressing.

In an optional embodiment, a plurality of membranes and a plurality of mesh sheets are provided, the plurality of membranes and the plurality of mesh sheets are arranged alternately in a circumferential direction of the hollow region, and adjacent membrane and mesh sheet are connected.

In an optional embodiment, the membrane is configured to be plastic sheet, and the mesh sheet is configured to be plastic sheet, cotton yarn sheet, or polyester sheet.

In an optional embodiment, the meshes are configured to be circular holes, elliptical holes, or polygonal holes.

In an optional embodiment, the first connecting end or the second connecting end is provided with a folded edge.

In a second aspect, the present disclosure provides a pull belt, wherein the pull belt is of a rectangular structure, and the pull belt includes a first membrane, a first mesh sheet, a third membrane, a second mesh sheet, and a second membrane that are disposed in parallel and connected sequentially to each other, wherein the first membrane, the first mesh sheet, the third membrane, the second mesh sheet, and the second membrane are all rectangular sheets.

In an optional embodiment, the membranes are pvc membranes, and the mesh sheets are plastic sheets, cotton yarn sheets, or polyester sheets.

In an optional embodiment, the high-frequency thermocompression welding is performed between the first membrane and the first mesh sheet, between the first mesh sheet and the third membrane, between the third membrane and the second mesh sheet, and between the second mesh sheet and the second membrane.

In an optional embodiment, the first mesh sheet and the second mesh sheet have the same length and width.

In an optional embodiment, the meshes are provided to be circular, oval, triangular, quadrilateral, or hexagonal.

In a third aspect, the present disclosure provides an inflatable-body pull belt structure, including:

an annular belt body having a hollow region, wherein the annular belt body is formed by the pull belt according to the second aspect by connecting the first membrane and the second membrane, and the first membrane and the second membrane connected to each other and the third membrane are all used to be connected to an inflatable body.

In an optional embodiment, the first membrane and the second membrane are connected by high-frequency thermocompression welding. In an optional embodiment, the annular belt body is configured as a cuboid structure having a hollow region, wherein the first mesh sheet and the second mesh sheet are provided as two opposite side surfaces of the cuboid structure extending along a lengthwise direction of the hollow region; and the first membrane and the second membrane that are connected and the third membrane are provided as two other opposite side surfaces of the cuboid structure.

In a fourth aspect, the present disclosure provides an inflatable product, wherein the inflatable product includes:

an inflatable body and the inflatable-body pull belt structure according to any one of the preceding embodiments, and the annular belt body is connected to the inflatable body.

In an optional embodiment, the inflatable body is configured as an inflatable bed, an inflatable swimming pool, an inflatable slide, or an inflatable floating mat.

The beneficial effects of the embodiments of the present disclosure are as follows:

to sum up, for the inflatable-body pull belt structure provided in the present disclosure, by providing a plurality of meshes on the annular belt body, the meshes can reduce the consumables of the annular belt body, and reduce the costs, and meanwhile, the weight of the annular belt body is reduced, and the transportation costs can be reduced. Moreover, the annular belt body, formed by a solid structure and a hollowed-out structure, can improve the tensile strength, and the use of an inflatable member is more stable. Moreover, in the present disclosure, by providing the pull belt as a combined structure constituted by the pvc membranes and the mesh sheets, the mesh sheets can increase the tensile strength, and the mesh sheets can reduce the consumables, thereby reducing the costs.

### BRIEF DESCRIPTION OF DRAWINGS

In order to more clearly illustrate technical solutions of embodiments of the present disclosure, accompanying drawings which need to be used in the embodiments will be introduced below briefly, and it should be understood that the accompanying drawings below merely show some embodiments of the present disclosure, and therefore should not be considered as limitation to the scope, and a person ordinarily skilled in the art still could obtain other relevant accompanying drawings according to these accompanying drawings, without using any creative effort.

FIG. 1 is a structural schematic view of an inflatable-body pull belt structure according to an embodiment of the present disclosure;

FIG. 2 is a schematic view of a modified structure of the inflatable-body pull belt structure according to an embodiment of the present disclosure;

FIG. 3 is a plane structural schematic view of an annular belt body of the inflatable-body pull belt structure according to an embodiment of the present disclosure;

FIG. 4 is a first schematic view of an application structure of the inflatable-body pull belt structure according to an embodiment of the present disclosure;

FIG. 5 is a second schematic view of the application structure of the inflatable-body pull belt structure according to an embodiment of the present disclosure;

FIG. 6 is a pull belt configured as a combined structure constituted by a pvc membrane and a mesh sheet according to an embodiment of the present disclosure;

FIG. 7 is a view of a physical pull belt in FIG. 6;

FIG. 8 is a structural schematic view of another inflatable-body pull belt structure according to an embodiment of the present disclosure;

FIG. 9 is a structural schematic view of the inflatable-body pull belt structure in FIG. 8 used in an inflatable swimming pool; and

FIG. 10 is a structural schematic view of the inflatable-body pull belt structure in FIG. 8 used in an inflatable slide.

### REFERENCE SIGNS

100—annular belt body; 110—hollow region; 120—mesh; 130—first connecting end; 140—second connecting end; 150—membrane; 160—mesh sheet; 170—folded edge; 1—first membrane; 2—first mesh sheet; 3—third membrane; 4—second mesh sheet; 5—second membrane; 6—first connecting portion; 7—second connecting portion.

### DETAILED DESCRIPTION OF EMBODIMENTS

In order to make objectives, technical solutions, and advantages of the embodiments of the present disclosure clearer, the technical solutions in the embodiments of the present disclosure will be described clearly and completely below in conjunction with the accompanying drawings in the embodiments of the present disclosure, and apparently, some but not all embodiments of the present disclosure are described. Generally, components in the embodiments of the present disclosure described and shown in the accompanying drawings herein may be arranged and designed in different configurations.

Therefore, the detailed description below of the embodiments of the present disclosure provided in the accompanying drawings is not intended to limit the scope of protection of the present disclosure, but merely represents chosen embodiments of the present disclosure. Based on the embodiments of the present disclosure, all of other embodiments, obtained by a person ordinarily skilled in the art without any creative effort, shall fall within the scope of protection of the present disclosure.

It should be noted that similar reference signs and letters represent similar items in the following accompanying drawings, therefore, once a certain item is defined in one accompanying drawing, it is not needed to be defined or explained in subsequent accompanying drawings.

In the description of the present disclosure, it should be indicated that orientation or positional relations indicated by terms such as “center”, “up”, “down”, “left”, “right”, “vertical”, “horizontal”, “inside”, and “outside”, if appear, are based on the orientation or positional relations shown in the drawings, or orientation or positional relations in which the product of the present disclosure is placed conventionally in use, only for facilitating description of the present disclosure and simplifying the description, rather than indicating or implying that the referred devices or elements must be in a particular orientation or constructed or operated in the particular orientation, and therefore they should not be construed as limitation to the present disclosure. Besides, terms “first”, “second”, “third”, etc. are merely for distinguishing the description, but should not be construed as indicating or implying importance in the relativity.

Moreover, terms “horizontal”, “vertical” and the like do not mean that the parts are required to be absolutely horizontal or overhanging, but may be slightly inclined. For example, by “horizontal” it merely means that a structure is more horizontal in comparison with “vertical”, rather than being completely horizontal, while the structure can be slightly inclined.

In the description of the present disclosure, it should be further illustrated that, unless otherwise specifically regulated and defined, the terms “set”, “install”, “link”, and “connect” should be understood in a broad sense, for example, a connection may be a fixed connection, a detachable connection, or an integrated connection; it may be a mechanical connection or an electrical connection; it may be direct joining or indirect joining through an intermediary, and it also may be inner communication between two elements. For those ordinarily skilled in the art, specific meanings of the above-mentioned terms in the present disclosure could be understood according to specific circumstances.

At present, taking an inflatable bed as an example, a plurality of pull belts are provided inside the inflatable bed, each pull belt is an annular belt, and is made of a complete pvc sheet, and two ends of the pull belt are fixed together with a bed wall of the inflatable bed, thereby functioning to position the inflatable bed. Since the existing pull belt is of a monolithic structure, the amount of consumables is large and the costs are high.

In view of this, a designer designs an inflatable-body pull belt structure, wherein by providing meshes 120 on the pull belt, in cases where the pull belts have the same shape and size, the pull belt having the meshes 120 requires fewer consumables, thus reducing the costs.

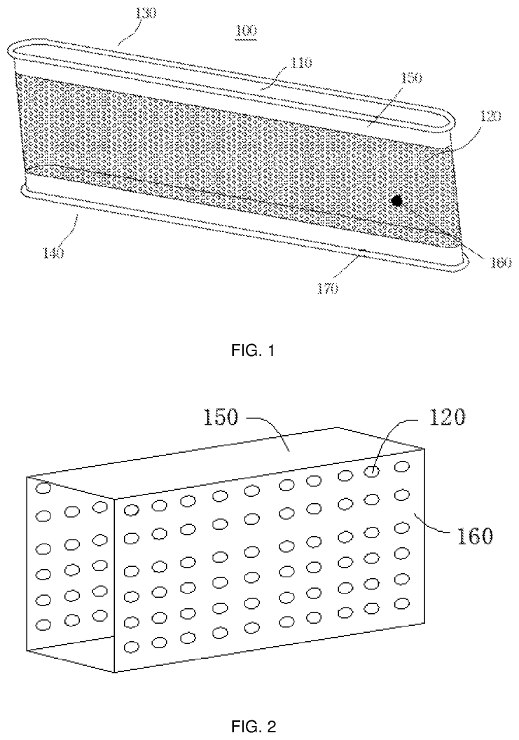

Referring to FIG. 1 or FIG. 2, in the present embodiment, the inflatable-body pull belt structure includes an annular belt body 100 having a hollow region 110, a plurality of meshes 120 which are all in communication with the hollow region 110 are provided on the annular belt body 100, the annular belt body 100 has a first connecting end 130 and a second connecting end 140 which are arranged in a lengthwise direction of the hollow region 110, the plurality of meshes 120 are located between the first connecting end 130 and the second connecting end 140, and both the first connecting end 130 and the second connecting end 140 are configured to be connected to the inflatable body.

The inflatable-body pull belt structure provided in the present embodiment has at least the following advantages:

by providing a plurality of meshes 120 on the annular belt body 100, the meshes 120 can reduce the consumables of the annular belt body 100 and reduce the costs, and meanwhile, the weight of the annular belt body 100 is reduced, and the transportation costs can be reduced. Moreover, the annular belt body 100, formed by a solid structure and a hollowed-out structure, can improve the tensile strength, and the use of an inflatable member is more stable.

It should be noted that a profile of cross section of the annular belt body 100 may be circular, oval, or waist-shaped, etc.

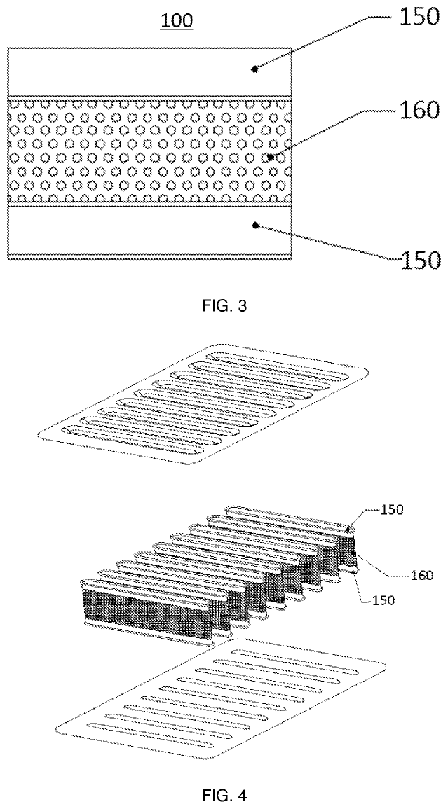

In the present embodiment, as shown in FIG. 3, the annular belt body 100 includes membranes 150 and a mesh sheet 160, wherein the membranes 150 and the mesh sheet 160 are all configured in an annular structure, the number of membranes 150 is two, the two membranes 150 are respectively arranged at two ends of the mesh sheet 160, and each membrane 150 can be fixedly connected to the mesh sheet 160 in a manner of high-frequency hot-pressing. One end of one of the membranes 150 away from the mesh sheet 160 is the first connecting end 130, and one end of the other membrane 150 away from the mesh sheet 160 is the second connecting end 140, and the annular belt body 100 is connected to an inner wall of the inflatable body through the two membranes 150. Meanwhile, the mesh sheet 160 is provided thereon with a plurality of meshes 120.

In the present embodiment, by providing the annular belt body 100 as a combined structure constituted by the membranes 150 and the mesh sheet 160, the mesh sheet can increase the tensile strength, and the mesh sheet can reduce the consumables, thereby reducing the costs.

It should be noted that a folded edge 170 may be provided at the end of each membrane 150 away from the mesh sheet 160, and the folded edge 170 may be folded outward or folded inward. In the present embodiment, illustration is made by taking that the folded edge 170 is folded outward as an example. Moreover, each folded edge 170 may be of an annular structure. By connecting the folded edges 170 and the inner wall of the inflatable body, contact areas can be enlarged, and firmness of the connection can be improved, and when the folded edges 170 folded outward are connected to the inflatable body, the folded edges 170 are less disturbed, facilitating the connection between the membranes 150 and the inflatable body.

Referring to FIG. 2, in other embodiments, optionally, each membrane 150 is a rectangular sheet, and the mesh sheet 160 is a rectangular sheet, a plurality of membranes 150 and a plurality of mesh sheets 160 are provided, and the plurality of membranes 150 and the plurality of mesh sheets 160 are arranged alternately in a circumferential direction of the hollow region 110, that is, in the circumferential direction of the hollow region 110, one membrane 150, one mesh sheet 160, one membrane 150, and one mesh sheet 160 are sequentially arranged, and adjacent membrane 150 and mesh sheet 160 are fixedly connected in a manner of high-frequency hot-pressing.

In the present embodiment, it should be noted that, the membranes 150 are configured to be plastic sheets, and the mesh sheets 160 are configured to be plastic sheets, cotton yarn sheets, polyester sheets, or the like.

In the present embodiment, it should be noted that the shape of each mesh 120 may be circular, elliptical, polygonal etc. The polygonal hole may be a quadrangular hole or a regular hexagonal hole or the like.

The inflatable-body pull belt structure provided in the present embodiment, by providing the meshes 120 on the annular belt body 100, reduces the consumables and reduces the costs.

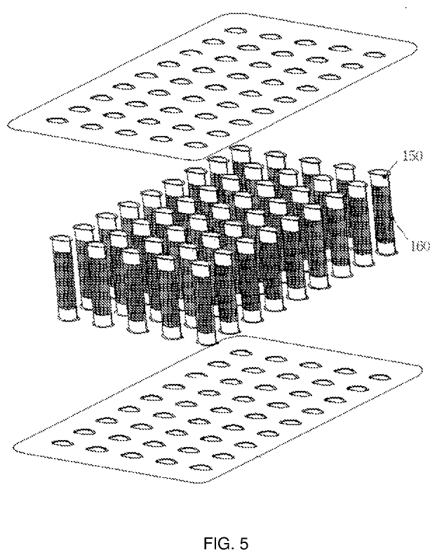

Referring to FIG. 4 and FIG. 5, the present embodiment further provides an inflatable product, wherein the inflatable product includes an inflatable body and an inflatable-body pull belt structure, the inflatable body has an inflatable chamber, and the annular belt body 100 is provided in the inflatable chamber and is in heat-seal connection with an inner wall of the inflatable body. It should be understood that the inflatable body may be an inflatable bed, an inflatable swimming pool, an inflatable slide, an inflatable floating mat, or the like. Moreover, the shape of the inflatable body may be set as required, which is not specifically limited in the present embodiment.

In addition, the number and positions of inflatable-body pull belt structures inside the inflatable body can be set as required.

The inflatable product provided in the present embodiment uses the pull belt structure having the meshes 120, thus reducing the consumables, reducing the costs, and also reducing the weight, and facilitating the transportation.

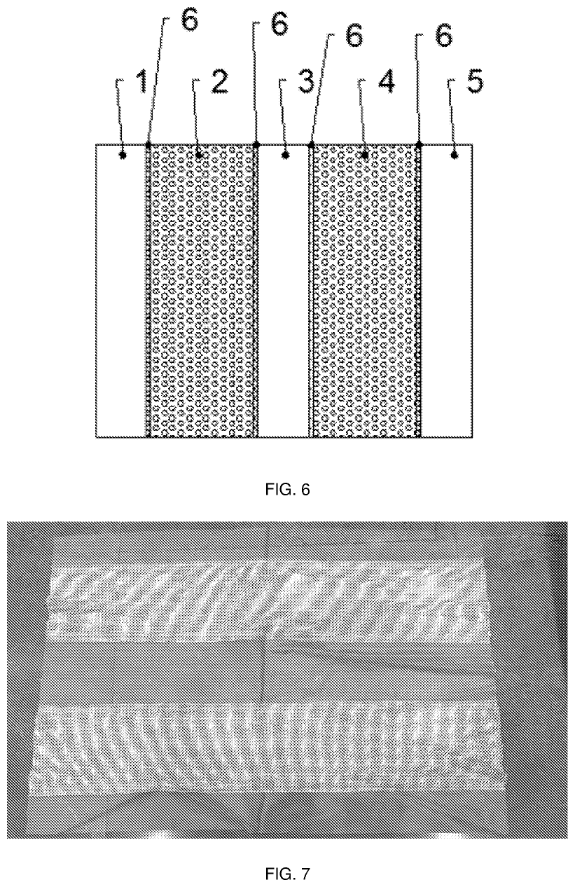

Referring to FIG. 6 and FIG. 7, the present disclosure further provides a pull belt, wherein the pull belt is of a rectangular structure, and includes a first membrane 1, a first mesh sheet 2, a third membrane 3, a second mesh sheet 4, and a second membrane 5 that are disposed in parallel and connected sequentially to each other, wherein the first membrane 1, the first mesh sheet 2, the third membrane 3, the second mesh sheet 4, and the second membrane 5 are all rectangular sheets.

In the present embodiment, the membranes and the mesh sheets are arranged alternately so as to form a five-layer structure having three layers of membranes and two layers of mesh sheets, wherein the membranes and the mesh sheets are all rectangular sheets, and the first membrane 1, the first mesh sheet 2, the third membrane 3, the second mesh sheet 4, and the second membrane 5 are arranged parallel to each other, moreover, lengths of sides of the first membrane 1, the first mesh sheet 2, the third membrane 3, the second mesh sheet 4, and the second membrane 5 which are subjected to high-frequency thermocompression welding are all the same, so that the resulting pull belt of a five-layer structure is of a rectangular structure.

In an optional embodiment, the membranes are pvc membranes, and the mesh sheets are plastic sheets, cotton yarn sheets, or polyester sheets.

In the present embodiment, by providing the pull belt as a combined structure constituted by the pvc membranes and the mesh sheets, the mesh sheets can increase the tensile strength, and the mesh sheets can reduce the consumables, thereby reducing the costs.

In an optional embodiment, the high-frequency thermocompression welding is performed between the first membrane 1 and the first mesh sheet 2, between the first mesh sheet 2 and the third membrane 3, between the third membrane 3 and the second mesh sheet 4, and between the second mesh sheet 4 and the second membrane 5.

It should be noted that, the connection manner between the membrane and the mesh sheet is not merely limited to the high-frequency thermocompression welding, and all connection manners capable of firmly connecting the membrane and the mesh sheet belong to the scope of protection of the present disclosure, and the present disclosure does not limit the specific connection manner.

In an optional embodiment, the first mesh sheet 2 and the second mesh sheet 4 have the same length and width.

In an optional embodiment, the meshes are provided to be circular, oval, triangular, quadrilateral, or hexagonal.

It should be noted that the present disclosure does not limit the specific shape of the mesh, as long as the technical effects of reducing the consumables and reducing the costs can be achieved, and the hexagonal mesh is taken as an example in the present embodiment.

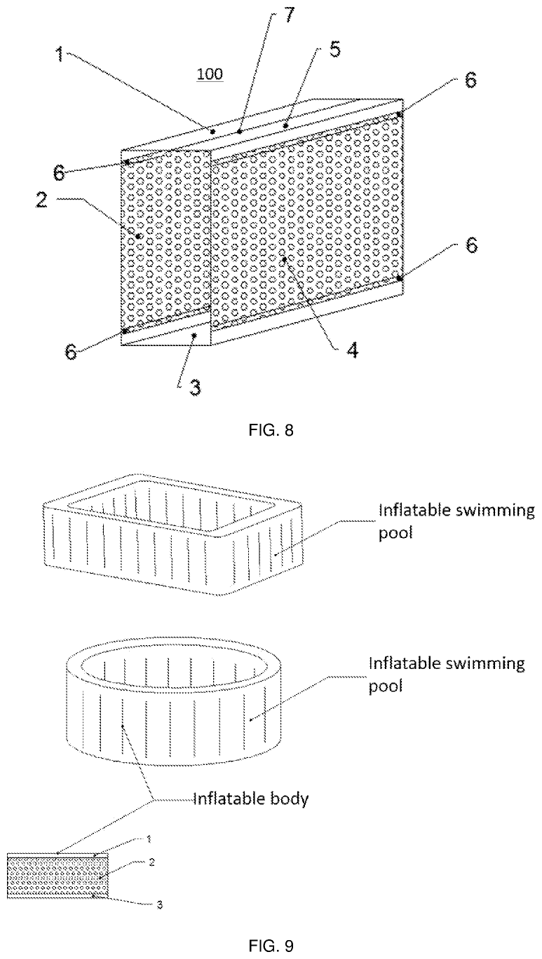

Referring to FIG. 8, the present disclosure further provides an inflatable-body pull belt structure, including:

an annular belt body 100 having a hollow region, wherein the annular belt body 100 is formed by the preceding pull belt by connecting a first membrane 1 and a second membrane 5, and the first membrane 1 and the second membrane 5 connected to each other and a third membrane 3 are all used to be connected to the inflatable body.

By providing a plurality of meshes on the annular belt body 100, the meshes can reduce the consumables of the annular belt body 100 and reduce the costs, and meanwhile, the weight of the annular belt body 100 is reduced, and the transportation costs can be reduced. Moreover, the annular belt body 100, formed by a solid structure and a hollowed-out structure, can improve the tensile strength, and the use of an inflatable member is more stable.

In the present embodiment, the first membrane 1 and the second membrane 5 of the preceding pull belt are connected, so that the pull belt forms the annular belt body 100 having the hollow region. The annular belt body 100 has four parts, i.e., a first part formed by connecting the first membrane 1 and the second membrane 5, a second part corresponding to the first mesh sheet 2, a third part corresponding to the second mesh sheet 4, and a fourth part corresponding to the third membrane 3, wherein the first part and the fourth part are configured to be connected to the inflatable body.

In an optional embodiment, the first membrane 1 and the second membrane 5 are welded by high-frequency thermocompression welding.

A connecting part of any one of the membranes and the mesh sheet is defined as a first connecting portion 6; and a connecting part of the first membrane 1 and the second membrane 5 is defined as a second connecting portion 7.

It should be noted that, the connection manner between the first membrane 1 and the second membrane 5 is not merely limited to the high-frequency thermocompression welding, and all connection manners capable of firmly connecting the first membrane 1 and the second membrane 5 belong to the scope of protection of the present disclosure, and the present disclosure does not limit the specific connection manner.

In an optional embodiment, the annular belt body 100 may be a cuboid structure having a hollow region, wherein the second part corresponding to the first mesh sheet 2 and the third part corresponding to the second mesh sheet 4 are provided as two opposite side surfaces of the cuboid structure extending along the lengthwise direction of the hollow region; and the first part formed by connecting the first membrane 1 and the second membrane 5 and the fourth part corresponding to the third membrane 2 are provided as two other opposite side surfaces of the cuboid structure.

It should be noted that, a typical structure of the annular belt body 100 includes, but is not limited to, the cuboid structure and a cylinder structure, and a specific structure of the annular belt body 100 is not limited in the present embodiment.

In the above, the inflatable body has an inflatable chamber, the annular belt body 100 is disposed in the inflatable chamber, and the first part and the fourth part of the annular belt body 100 are connected to the inner wall of the inflatable body.

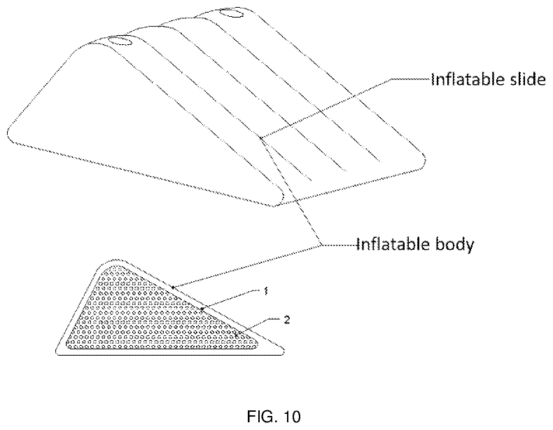

It should be understood that the inflatable body may be an inflatable bed, an inflatable swimming pool (as shown in FIG. 9), an inflatable slide (as shown in FIG. 10), an inflatable floating mat, or the like. Furthermore, the shape of the inflatable body can be set as required, which is not specifically limited in the present embodiment; and the connection manner of the first part and the fourth part of the annular belt body 100 and the inner wall of the inflatable body can be selected according to actual needs, including but not limited to heat seal connection, and the present embodiment does not limit the specific connection manner.

In addition, the number and positions of inflatable-body pull belt structures inside the inflatable body can be set as required, and the specific number and connection positions are not limited in the present embodiment. The above-mentioned are only preferred embodiments of the present disclosure and are not intended to limit the present disclosure. For a person skilled in the art, the present disclosure may have various modifications and changes. Any modifications, equivalent substitutions, improvements and the like made within the spirit and principle of the present disclosure should be covered within the scope of protection of the present disclosure.

### INDUSTRIAL APPLICABILITY

To sum up, for the inflatable-body pull belt structure provided in the present embodiment, by providing a plurality of meshes on the annular belt body, the meshes can reduce the consumables of the annular belt body, and reduce the costs, and meanwhile, the weight of the annular belt body is reduced, and the transportation costs can be reduced. Moreover, the annular belt body, formed by a solid structure and a hollowed-out structure, can improve the tensile strength, and the use of an inflatable member is more stable. Moreover, in the present disclosure, by providing the pull belt as a combined structure constituted by the pvc membranes and the mesh sheets, the mesh sheets can increase the tensile strength, and the mesh sheets can reduce the consumables, thereby reducing the costs.

1. An inflatable-body pull belt structure, comprising:
an annular belt body having a hollow region, wherein a plurality of meshes which are all in communication with the hollow region are provided on the annular belt body, the annular belt body has a first connecting end and a second connecting end which are arranged in a lengthwise direction of the hollow region, the plurality of meshes are located between the first connecting end and the second connecting end, and both the first connecting end and the second connecting end are configured to be connected to an inflatable body;
the annular belt body comprises a membrane and a mesh sheet, and the membrane and the mesh sheet are connected and define the hollow region together;
wherein the membrane and the mesh sheet are both in an annular shape, and the number of membranes is two and the two membranes are respectively fixedly connected to two ports of the mesh sheet;
wherein a plurality of membranes and a plurality of mesh sheets are provided, the plurality of membranes and the plurality of mesh sheets are arranged alternately in a circumferential direction of the hollow region, and adjacent membrane and mesh sheet are connected to each other;
wherein the membranes and the mesh sheets are connected in a manner of high-frequency bot-pressing, every two of the mesh sheets are connected to two ends of one of the membranes in the manner of high-frequency hot-pressing, respectively, and each of the mesh sheets is provided with the plurality of meshes.

2. (canceled)

3. (canceled)

4. (canceled)

5. (canceled)

6. The inflatable-body pull belt structure according to claim 4, wherein the membrane is configured to be plastic sheet, and the mesh sheet is configured to be plastic sheet, cotton yarn sheet, or polyester sheet.

7. The inflatable-body pull belt structure according to claim 6, wherein the meshes are configured to be circular holes, elliptical holes, or polygonal holes.

8. The inflatable-body pull belt structure according to claim 6, wherein the first connecting end or the second connecting end is provided with a folded edge.

9. (canceled)

10. (canceled)

11. A pull belt, wherein the pull belt is of a rectangular structure, and the pull belt comprises a first membrane, a first mesh sheet, a third membrane, a second mesh sheet, and a second membrane that are disposed in parallel and connected sequentially to each other, wherein the first membrane, the first mesh sheet, the third membrane, the second mesh sheet, and the second membrane are all rectangular sheets.

12. The pull belt according to claim 11, wherein membranes are pvc membranes, and mesh sheets are plastic sheets, cotton yarn sheets, or polyester sheets.

13. The pull belt according to claim 11, wherein the high-frequency thermocompression welding is performed between the first membrane and the first mesh sheet, between the first mesh sheet and the third membrane, between the third membrane and the second mesh sheet, and between the second mesh sheet and the second membrane.

14. The pull belt according to claim 11, wherein the first mesh sheet and the second mesh sheet have the same length and width.

15. The pull belt according to claim 11, wherein meshes are provided to be circular, oval, triangular, quadrilateral, or hexagonal.

16. An inflatable-body pull belt structure, comprising:
an annular belt body having a hollow region, wherein the annular belt body is formed by the pull belt according to claim 11 by connecting the first membrane and the second membrane, and the first membrane and the second membrane connected to each other and the third membrane are all used to be connected to an inflatable body.

17. The inflatable-body pull belt structure according to claim 16, wherein the first membrane and the second membrane are connected by high-frequency thermocompression welding.

18. The inflatable-body pull belt structure according to claim 16, wherein the annular belt body is configured as a cuboid structure having a hollow region, wherein the first mesh sheet and the second mesh sheet are provided as two opposite side surfaces of the cuboid structure extending along a lengthwise direction of the hollow region; and the first membrane and the second membrane that are connected and the third membrane are provided as two other opposite side surfaces of the cuboid structure.

19. The inflatable-body pull belt structure according to claim 1, wherein
the membrane is configured to be plastic sheet, and the mesh sheet is configured to be plastic sheet, cotton yarn sheet, or polyester sheet.
